(19) United States
(12) Patent Application Publication
(10) Pub. No.: US 2006/0068608 A1
(43) Pub. Date: Mar. 30, 2006

(54) Rotatable outlet adaptor

(76) Inventor: Orrin H. McFadden, Long Beach, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 10/954,716

(22) Filed: Sep. 30, 2004

(51) Int. Cl. H01R 39/00

(52) U.S. Cl. 439/22

(57) ABSTRACT

An outlet adaptor includes a housing that has an inner section and an outer section rotatably connected thereto. Such an outer section has a front face provided with a plurality of conductive input ports formed therein and the inner section has a rear face oppositely spaced from the front face that includes a plurality of conductive output prongs operably coupled to the input ports. A mechanism is included for maintaining continuous electrical contact between the input ports and the output prongs while the outer section is rotated about the inner section. Such an electrical contact mechanism is disposed generally medially of the front and rear faces.

### CROSS REFERENCE TO RELATED APPLICATIONS

Not Applicable.

### STATEMENT REGARDING FEDERALLY SPONSORED

### RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to an outlet adapter and, more particularly, to a rotatable outlet adapter for being electrically mated with a conventional power outlet such that the adaptor facilitates the attachment of electronic devices to the outlet.

2. Prior Art

Electrical connectors, junction boxes and other devices designed to extend the source of electrical power within buildings are generally known in the prior art. However, none of these devices address the problem associated with conveniently accessing electrical outlets that may be blocked by other plugs already in place within one outlet.

One attempt to do so relates to a baseboard for electrical installations having a cover part which is fastened to a wall. The cover part has a plurality of extending bare wires that may be readily connected to adapters to form an electrical switch apparatus or distributing elements in the baseboard. Such a method is very unsafe and not practical in use.

One solution would be to have a rotatable socket member. There is known a plug receptacle having such a rotatable ball member. This plug receptacle is advantageous in that the plug can be pulled in any of a certain range of directions for detachment from the receptacle since the plug pin openings turn to face the same direction.

The device, however, comprises a socket member adapted to be stationarily supported on a wall of a room or the like and a ball member enclosed in the socket member. Complicated means are required to hold the ball member rotatably in the socket member. The ball member cannot easily be separated from the socket member, because the greater portion of the ball member is enclosed within the socket member. The plug receptacle of such construction disadvantageously requires a great expenditure of time and labor for internal inspection in case of electrical failure therein.

This device is further disadvantageous because it requires complicated means for establishing adequate electrical connection between the ball and socket members, while maintaining the necessary rotatability of the ball member relative to the socket member.

Accordingly, a need remains for a rotatable outlet adapter in order to overcome the above-noted shortcomings. The present invention satisfies such a need by providing an adapter that is easy to use and install, reasonably priced, results in time savings, and has the ability to provide an increased level of safety in the home or workplace. Such an adapter conveniently gives a user access to outlets that might otherwise be blocked, thus advantageously reducing the number of outlets necessary. The device advantageously appeals to both homeowners and business owners due to the fact that it eliminates the costly need of installing extra power outlets.

### BRIEF SUMMARY OF THE INVENTION

In view of the foregoing background, it is therefore an object of the present invention to provide a rotatable outlet adapter. These and other objects, features, and advantages of the invention are provided by a rotatable outlet adaptor that is electrically mated with a conventional power outlet such that the adaptor facilitates the attachment of electronic devices to the outlet.

The adaptor includes a housing that has a centrally disposed longitudinal axis and includes an inner section and an outer section rotatably connected thereto. Such an outer section has a front face provided with a plurality of conductive input ports formed therein and situated substantially parallel to the axis. The inner section has a rear face oppositely spaced from the front face and includes a plurality of conductive output prongs operably coupled to the input ports such that an electrical charge can be effectively transmitted therebetween when the output prongs are mated to the outlet. Each of the input ports and each of the output prongs are preferably equidistantly offset from the axis such that annular movement of the outer section maintains the input ports radially spaced from the axis and within a path defined by each the tracks respectively.

The inner section preferably includes an outer surface provided with a plurality of integrally spaced annular ribs extending about the axis. The outer section has an inner surface positioned about the inner section and is provided with a plurality of annular notches for respectively receiving the ribs therein. The outer section is guided along a radial path defined by the ribs so that the contacts can advantageously remain electrically engaged during operating conditions. Such ribs and tracks are formed along parallel planes for effectively cooperating with each other during operating conditions. The inner section may be countersunk in a wall and permanently mated with the outlet such that the device can conveniently be partially hidden behind a face plate of the outlet.

A mechanism is included for maintaining continuous electrical contact between the input ports and the output prongs while the outer section is rotated about the inner section so that a power cord of the device can be rotated in sync with the outer section along clockwise and counter clockwise directions. Such an electrical contact mechanism is disposed generally medially of the front and rear faces.

The electrical contact mechanism preferably includes a plurality of conductive concentric tracks centered about the axis and formed within the inner section. A plurality of electrical contacts extend outwardly from the input ports and the output prongs Wherein corresponding pairs of the contacts are electrically coupled within associated ones of the tracks. Such tracks guide the contact pairs along a radial path as the outer section is rotated about the inner section. One of the tracks preferably receives a power supply and is centrally positioned along the axis.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a rear perspective view showing a rotatable outlet adapter for being electrically mated with a conventional power outlet, in accordance with the present invention;

FIG. 2 is a front perspective view of the adapter shown in FIG. 1, showing the input ports;

FIG. 3 is a cross-sectional view of the adapter shown in FIG. 1, taken along line 3-3;

FIG. 4 is a cross-sectional view of the adapter shown in FIG. 3, taken along line 4-4;

FIG. 5 is a cross-sectional view of the adapter shown in FIG. 3, taken along line 5-5;

FIG. 6 is a front elevational view showing the inner section counter sunk into a wall; and

FIG. 7 is a side elevational view of the counter sunk adapter shown in FIG. 6.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

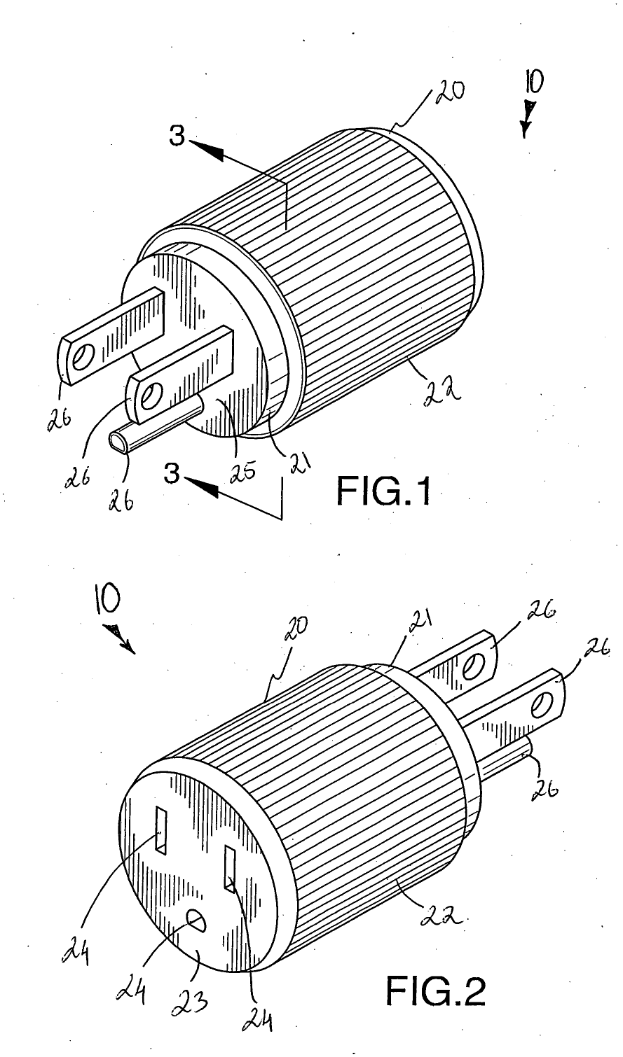

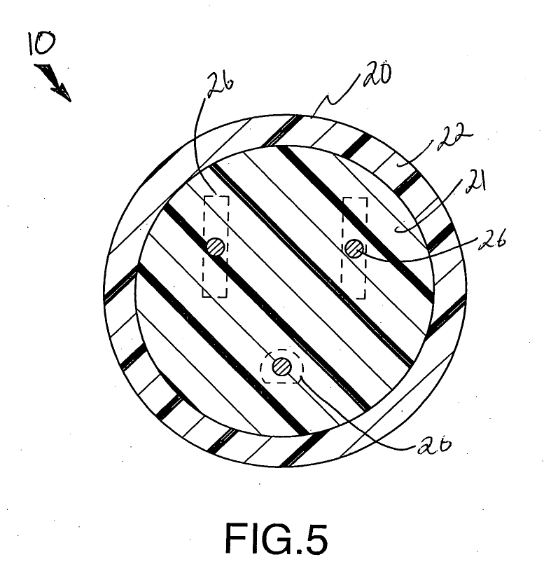

The device of this invention is referred to generally in FIGS. 1-7 by the reference numeral 10 and is intended to provide a rotatable outlet adapter. It should be understood that the device 10 may be used to adapt many different types of outlets and should not be limited to only those found in residences.

Referring initially to FIGS. 1 and 2, the device 10 includes a housing 20 that has a centrally disposed longitudinal axis and includes an inner section 21 and an outer section 22 rotatably connected thereto. Such an outer section 22 has a front face 23 provided with a plurality of conductive input ports 24 formed therein and situated substantially parallel to the axis. The inner section 21 has a rear face 25 oppositely spaced from the front face 23 and includes a plurality of conductive output prongs 26 operably coupled to the input ports 24 such that an electrical charge can be effectively transmitted therebetween when the output prongs 26 are mated to the outlet. Each of the input ports 24 and each of the output prongs 26 are equidistantly offset from the axis such that annular movement of the outer section 22 maintains the input ports 24 radially spaced from the axis and within a path defined by each of the tracks 41 (described herein below) respectively.

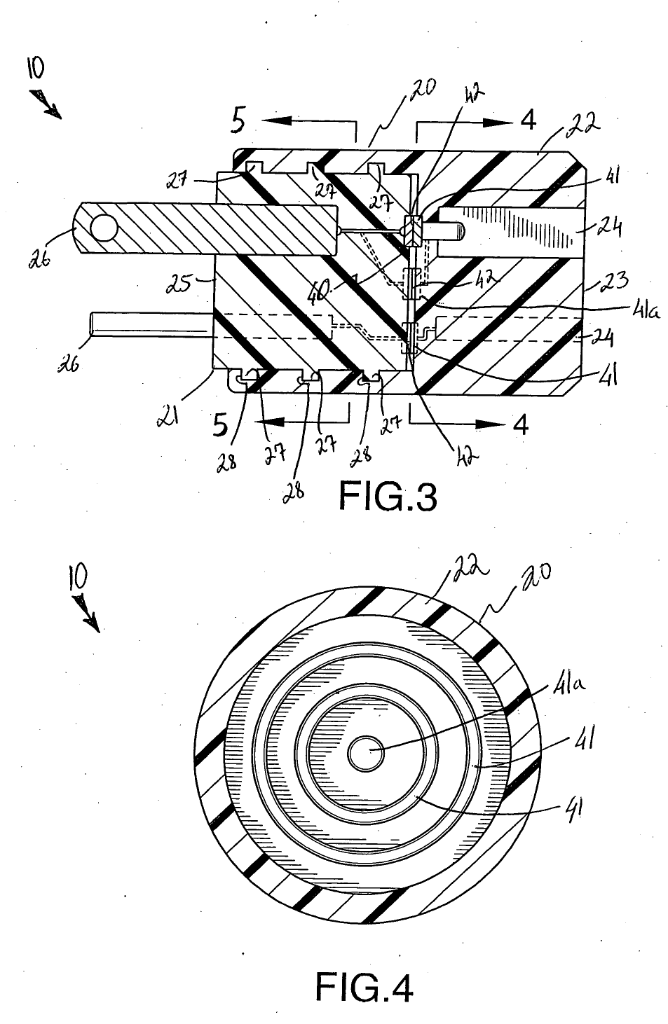

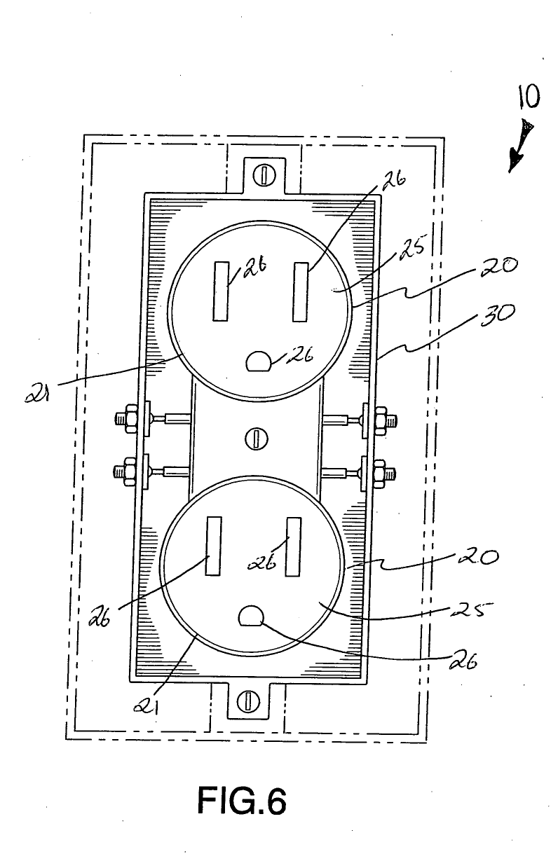

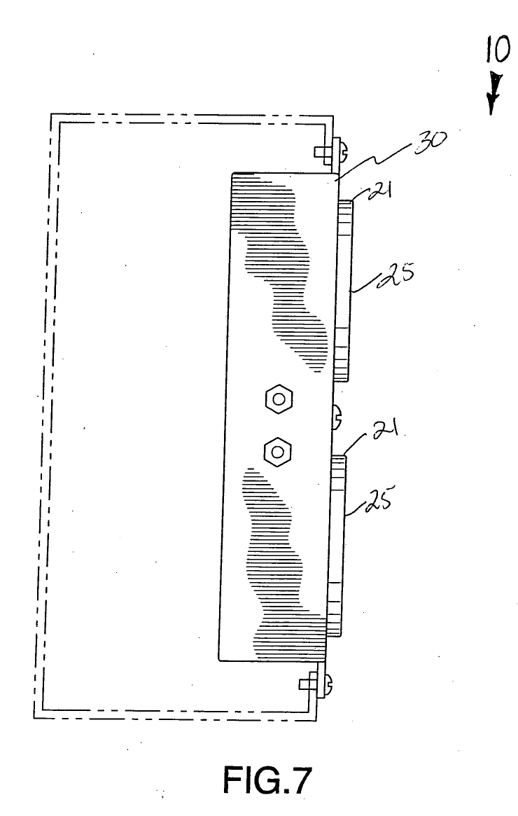

Referring to FIG. 3, the inner section 21 includes an outer surface provided with a plurality of integrally spaced annular ribs 27 extending about the axis. The outer section 22 has an inner surface positioned about the inner section and is provided with a plurality of annular notches 28 for respectively receiving the ribs 27 therein, thus conveniently preventing the inner 21 and outer 22 sections from coming apart. The outer section 22 is guided along a radial path defined by the ribs 27 so that the contacts 42 (described herein below) can advantageously remain electrically engaged during operating conditions. Such ribs 27 and tracks 28 are formed along parallel planes for effectively cooperating with each other during operating conditions. The inner section 21 may, of course, be countersunk in a wall and permanently mated with the outlet 30 so that the device 10 can conveniently be partially hidden behind a face plate of the outlet 30, as shown in FIGS. 6 and 7.

Referring to FIGS. 3, 4 and 5, a mechanism 40 is included for maintaining continuous electrical contact between the input ports 24 and the output prongs 26 while the outer section 22 is rotated about the inner section 21 such that a power cord of the device 10 can be rotated in sync with the outer section 22 along clockwise and counter clockwise directions. This advantageously allows an outlet previously blocked by a plug to be unblocked and usable. Such an electrical contact mechanism 40 is disposed generally medially of the front 23 and rear 25 faces.

Still referring to FIGS. 3, 4 and 5, the electrical contact mechanism 40 includes a plurality of conductive concentric tracks 41 centered about the axis and formed within the inner section 21. A plurality of electrical contacts 42 extend outwardly from the input ports 24 and the output prongs 26 wherein corresponding pairs of the contacts 42 are electrically coupled within associated ones of the tracks 41. Such tracks 41 guide the contact pairs 42 along a radial path as the outer section 22 is rotated about the inner section 21. One of the tracks 41a receives a power supply and is centrally positioned along the axis.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A rotatable outlet adaptor for being electrically mated with a conventional power outlet such that said adaptor facilitates the attachment of electronic devices to the outlet, said adaptor comprising:
a housing having a centrally disposed longitudinal axis and comprising an inner section and an outer section rotatably connected thereto, said outer section having a front face provided with a plurality of conductive input ports formed therein and situated substantially parallel to the axis, said inner section including a plurality of conductive output prongs operably coupled to said input ports such that an electrical charge can be transmitted therebetween when said output prongs are mated to the outlet; and
means for maintaining continuous electrical contact between said input ports and said output prongs while said outer section is rotated about said inner section such that a power cord of the device can be rotated in sync with said outer section and along clockwise and counter clockwise directions.

2. The outlet adaptor of claim 1, wherein said electrical contact means comprises:
a plurality of conductive concentric tracks centered about the axis and formed within said inner section;
a plurality of electrical contacts extending outwardly from said input ports and said output prongs wherein corresponding pairs of said contacts are electrically coupled within associated ones of said tracks, said tracks for guiding said contact pairs along a radial path as said outer section is rotated about said inner section.

3. The outlet adaptor of claim 2, wherein each said input ports and each said output prongs are equidistantly offset from the axis such that annular movement of said outer section maintains said input ports radially spaced from the axis and within a path defined by each said tracks respectively.

4. The outlet adaptor of claim 2, wherein one said tracks receives a power supply and is centrally position along the axis.

5. The outlet adaptor of claim 2, wherein said inner section includes an outer surface provided with a plurality of integrally spaced annular ribs extending about the axis, said outer section having an inner surface positioned about said inner section and being provided with a plurality annular notches for respectively receiving said ribs therein, said outer section being guided along a radial path defined by said ribs so that said contacts can remained electrically engaged during operating conditions, said ribs and said tracks being formed along parallel planes for cooperating with each other during operating conditions.

6. The outlet adaptor of claim 1, wherein said inner section is countersunk in a wall and permanently mated with the outlet such that said device can be partially hidden behind a face plate of the outlet.

7. A rotatable outlet adaptor for being electrically mated with a conventional power outlet such that said adaptor facilitates the attachment of electronic devices to the outlet, said adaptor comprising:
a housing having a centrally disposed longitudinal axis and comprising an inner section and an outer section rotatably connected thereto, said outer section having a front face provided with a plurality of conductive input ports formed therein and situated substantially parallel to the axis, said inner section having a rear face oppositely spaced from said front face and including a plurality of conductive output prongs operably coupled to said input ports such that an electrical charge can be transmitted therebetween when said output prongs are mated to the outlet; and
means for maintaining continuous electrical contact between said input ports and said output prongs while said outer section is rotated about said inner section such that a power cord of the device can be rotated in sync with said outer section and along clockwise and counter clockwise directions.

8. The outlet adaptor of claim 7, wherein said electrical contact means comprises:
a plurality of conductive concentric tracks centered about the axis and formed within said inner section;
a plurality of electrical contacts extending outwardly from said input ports and said output prongs wherein corresponding pairs of said contacts are electrically coupled within associated ones of said tracks, said tracks for guiding said contact pairs along a radial path as said outer section is rotated about said inner section.

9. The outlet adaptor of claim 8, wherein each said input ports and each said output prongs are equidistantly offset from the axis such that annular movement of said outer section maintains said input ports radially spaced from the axis and within a path defined by each said tracks respectively.

10. The outlet adaptor of claim 8, wherein one said tracks receives a power supply and is centrally position along the axis.

11. The outlet adaptor of claim 8, wherein said inner section includes an outer surface provided with a plurality of integrally spaced annular ribs extending about the axis, said outer section having an inner surface positioned about said inner section and being provided with a plurality annular notches for respectively receiving said ribs therein, said outer section being guided along a radial path defined by said ribs so that said contacts can remained electrically engaged during operating conditions, said ribs and said tracks being formed along parallel planes for cooperating with each other during operating conditions.

12. The outlet adaptor of claim 8, wherein said inner section is countersunk in a wall and permanently mated with the outlet such that said device can be partially hidden behind a face plate of the outlet.

13. A rotatable outlet adaptor for being electrically mated with a conventional power outlet such that said adaptor facilitates the attachment of electronic devices to the outlet, said adaptor comprising:
a housing having a centrally disposed longitudinal axis and comprising an inner section and an outer section rotatably connected thereto, said outer section having a front face provided with a plurality of conductive input ports formed therein and situated substantially parallel to the axis, said inner section having a rear face oppositely spaced from said front face and including a plurality of conductive output prongs operably coupled to said input ports such that an electrical charge can be transmitted therebetween when said output prongs are mated to the outlet; and
means for maintaining continuous electrical contact between said input ports and said output prongs while said outer section is rotated about said inner section such that a power cord of the device can be rotated in sync with said outer section and along clockwise and counter clockwise directions, said electrical contact means being disposed generally medially of said front and rear faces.

14. The outlet adaptor of claim 13, wherein said electrical contact means comprises:
a plurality of conductive concentric tracks centered about the axis and formed within said inner section;
a plurality of electrical contacts extending outwardly from said input ports and said output prongs wherein corresponding pairs of said contacts are electrically coupled within associated ones of said tracks, said tracks for guiding said contact pairs along a radial path as said outer section is rotated about said inner section.

15. The outlet adaptor of claim 14, wherein each said input ports and each said output prongs are equidistantly offset from the axis such that annular movement of said outer section maintains said input ports radially spaced from the axis and within a path defined by each said tracks respectively.

16. The outlet adaptor of claim 14, wherein one said tracks receives a power supply and is centrally position along the axis.

17. The outlet adaptor of claim 14, wherein said inner section includes an outer surface provided with a plurality of integrally spaced annular ribs extending about the axis, said outer section having an inner surface positioned about said inner section and being provided with a plurality annular notches for respectively receiving said ribs therein, said outer section being guided along a radial path defined by said ribs so that said contacts can remained electrically engaged during operating conditions, said ribs and said tracks being formed along parallel planes for cooperating with each other during operating conditions.

18. The outlet adaptor of claim 14, wherein said inner section is countersunk in a wall and permanently mated with the outlet such that said device can be partially hidden behind a face plate of the outlet.
